(19) United States
(12) Patent Application Publication
(10) Pub. No.: US 2005/0270279 A1
(43) Pub. Date: Dec. 8, 2005

(54) Electroluminescent display and electronic device comprising such a display

(75) Inventors: Andrea Giraldo, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Groenewoudseweg 1 (NL)

(21) Appl. No.: 10/521,717

(22) PCT Filed: Jul. 8, 2003
(86) PCT No.: PCT/IB03/03014

§ 371 Date: Jan. 19, 2005

(30) Foreign Application Priority Data
Jul. 23, 2002 (EP) 02077998.9

(51) Int. Cl. G09G 5/00

(52) U.S. Cl. 345/204

(57) ABSTRACT

The invention relates to an electroluminescent display comprising a first display pixel and a second display pixel formed on a substrate. The display pixels comprise a first electrode deposited on or across the substrate, an electroluminescent layer and a second reflective electrode. The first and second display pixels are separated by a region comprising at least one insulating structure. The insulating structure is adapted to suppress the output of light at the second display pixel reflected at the second reflective electrode, which light is incident from at least the first display pixel and/or the substrate. The insulating structure reduces crosstalk of light between the first and second or further display pixel and can be easily integrated in the manufacturing process of the electroluminescent display.

The invention relates to an electroluminescent display comprising at least a first display pixel and a second display pixel formed on a substrate, said first and second display pixels comprising at least:
a first electrode deposited on or across said substrate,
an electroluminescent layer, and
a second reflective electrode,
   wherein said first display pixel and said second display pixel are separated by a region comprising at least one insulating structure. Moreover, the invention relates to an electronic device comprising such an electroluminescent display.

U.S. Pat. No. 5,989,785 discloses an electroluminescent device comprising display pixels formed on a substrate comprising luminescent regions sandwiched between two electrodes. The light output of a luminescent region can be influenced by the light output of another luminescent region, i.e. crosstalk of light. The crosstalk of light between the luminescent regions is minimised by isolating the luminescent regions by means of a dielectric film. The refractive index of the film is chosen to be totally reflecting the light incident from a luminescent region back into the same luminescent region.

However, in many instances crosstalk of light between the display pixels in prior-art electroluminescent displays is still manifest. Crosstalk of light can eventually result in the presence of ghost images on the electroluminescent display, i.e. individual display pixels seem to be ‘on’ while they are not activated by the display control means. Moreover, attempts to minimise crosstalk by adapting the structure of the display pixels has resulted in many additional manufacturing steps.

It is an object of the invention to provide an electroluminescent display that substantially reduces crosstalk of light between the display pixels due to light emanating from adjacent pixels and/or ambient light from outside the display.

This object is achieved by providing an electroluminescent display, which is characterized in that said insulating structure is adapted to suppress the output of light at said second display pixel reflected at said second reflective electrode, which light is incident from at least said first display pixel and/or said substrate.

This insulating structure suppresses, reduces or even eliminates the crosstalk of light between display pixels as a result of reflection at the second reflective electrode and thereby reduces the possibility of ghost images on the electroluminescent display.

In a preferred embodiment of the invention, the insulating structure comprises at least one edge near or along said second display pixel. Such an edge can e.g. be created by accommodation of the display pixels in holes formed in an insulating layer. This embodiment has the advantage that creation of such an insulating structure does not lead to an additional step in the manufacturing process of the electroluminescent display. The insulating structure may exhibit slanting side walls towards at least one of the display pixels having an angle Φ towards a display pixel. In choosing the angle of the slanted side wall with the substrate carefully, the crosstalk of light between the display pixels via the second electrode can be effectively suppressed, depending on the desired viewing angle. In a preferred embodiment, the angle Φ is larger than 40°, because in that case the crosstalk of light is effectively suppressed for every viewing angle.

In a preferred embodiment of the invention, the insulating structure is made at least partly of a material having a high refractive index. The insulating structure is preferably made of TiO₂ or SnO₂. Replacing a conventional dielectric layer by such a dielectric insulating layer with a higher refractive index does not lead to an additional manufacturing step for such an electroluminescent device, while crosstalk of light between the display pixels is suppressed.

In a preferred embodiment of the invention, the slanting side wall of the insulating structure comprises a roughened surface or a curved surface. Such a structure can be easily obtained and provides an effective way of reducing crosstalk of light between the display pixels of the electroluminescent display.

Except for adapting the angle, material or surface of the side wall of the insulating structure, light-absorbing means can also be used to prevent crosstalk of light between the display pixels. In a preferred embodiment of the invention, the insulating structure comprises light-absorbing particles. Moreover, an absorbing grid, e.g. a black matrix, can be deposited underneath the slanting side wall of the insulating layer. Also the second electrode can be partially removed and replaced by a light-absorbing material. The embodiments comprising light-absorbing materials are simple with regard to manufacturing and provide effective suppression of the crosstalk of light between the display pixels of the electroluminescent display.

U.S. Pat. No. 6,901,195 discloses an electroluminescent display comprising reflectors for reducing crosstalk of light between the various devices of the electroluminescent display. Manufacturing of such an electroluminescent display is complicated and requires additional process steps and components as compared to the electroluminescent display according to the invention.

It will be appreciated that the previous embodiments or aspects of the previous embodiments of the invention can be combined.

The embodiments of the invention will be described in more detail below with reference to the attached drawing, in which

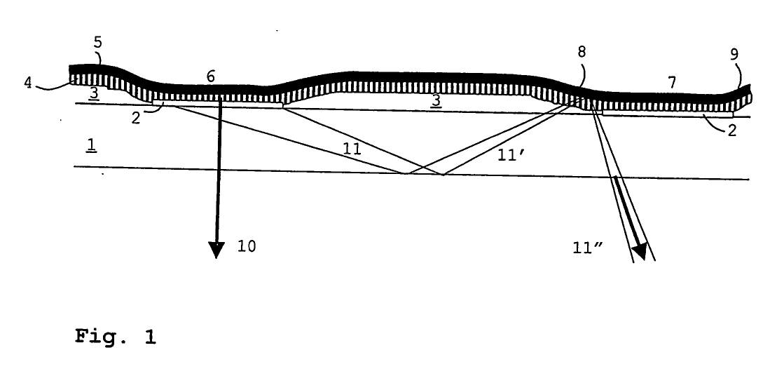

FIG. 1 is a cross-section of a conventional active matrix electroluminescent display.

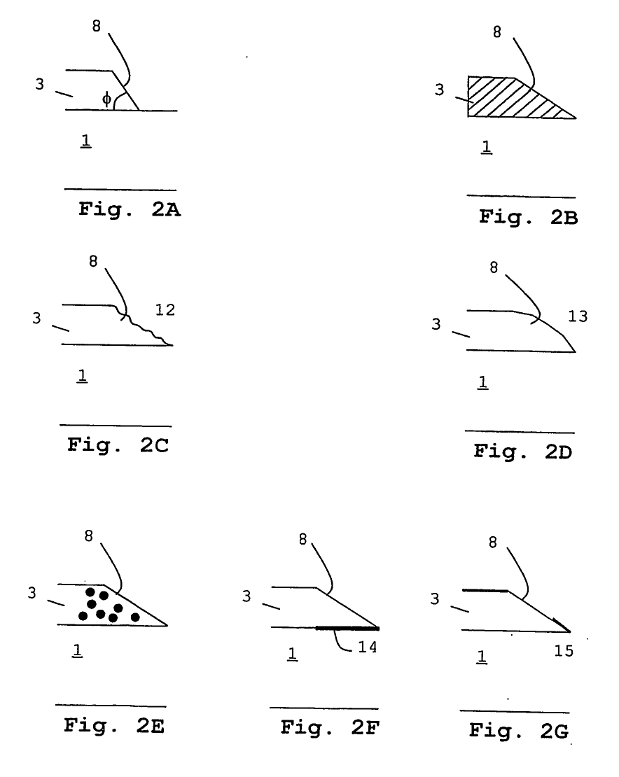

FIGS. 2A-2G show various embodiments of the invention.

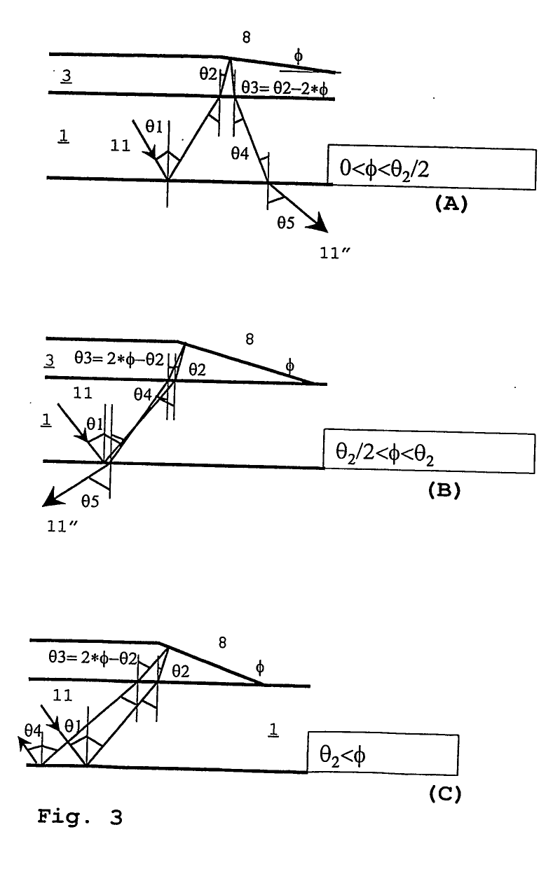

FIG. 3 shows an example of the embodiment of the invention illustrated in FIG. 2A.

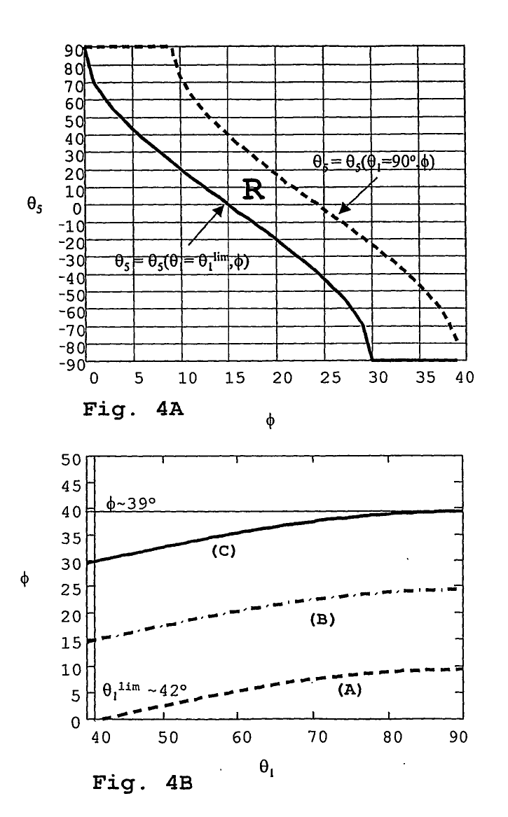

FIGS. 4A and 4B show the results of calculations performed for the embodiment of the invention illustrated in FIG. 2A.

FIG. 1 is a part of a cross-section of a conventional active matrix luminescent display (not to scale). The active matrix display comprises a substrate 1 carrying first electrodes 2, an insulation layer 3, an organic luminescent layer 4 and a second electrode 5. In this configuration, the electroluminescent display exhibits various display pixels 6, 7 arranged in rows and columns. The electroluminescent display and/or the display pixels may comprise several additional layers, metallic layers (e.g. for providing capacitors), further insulating layers (e.g. for defining cross-overs) and semiconducting layers (e.g. for providing thin-film transistors).

The substrate 1 is preferably made of a transparent material such as glass or plastic. The thickness of the substate is e.g. 700 μm. The transparent substrate 1 is covered by the first electrodes 2, at least at the sites where the display pixels 6, 7 are to be accommodated. The first electrodes 2 are formed on the substrate by a deposition process, such as sputtering. These first electrodes 2 are preferably transparent with respect to the light to be generated in the luminescent layer 4. Typically, these first electrodes 2 are made from Indium-Tin-Oxide (ITO), but different conductive and transparent materials, such as conductive polymers (polyaniline (PANI) or a poly-3,4-ethylenedioxythiophene (PEDOT)) can also be applied. During the manufacturing of the electroluminescent display, a (dielectric) insulating layer 3 is deposited on top of the first electrodes 2 and subsequently removed on the sites where the display pixels 6 and 7 are to be formed. In this example, the dielectric insulating layer 3 was made of SiN and has a thickness of 0.5 μm. In fact, the insulating layer 3 separates the display pixels 6 and 7 by the formation of holes in the insulating layer exhibiting slanting side walls 8, 9 towards these display pixels. The width of the display pixels 6, 7 is e.g. 50 μm and the display pixels are separated by a region over a distance of 30 μm of which the slanting side walls 8, 9 take 5 μm each. It is noted that the insulating layer 3 may extend across the edges of the first electrodes 2 next to the slanting side wall 8, provided that electrical contact with the first electrode 2 can be established. In this case, the width of the insulating layer or structure 3 is thus larger than the width of the region separation of the display pixels 6 and 7. The first electrodes 2 or insulating layer 3 are covered by the electroluminescent layer 4 or a layer comprising an electroluminescent material, such as certain organic materials like poly-p-phenylenes (PPV) or derivatives thereof. The electroluminescent layer 4 can be deposited by using vacuum deposition, chemical vapour deposition or fluid-using techniques such as spin-coating, dip-coating or inkjet printing. The electroluminescent layer 4 is covered by the second electrode 5, at least at the sites where the display pixels 6, 7 are to be formed. The second electrode is a metal and is highly reflective.

It is noted that while FIG. 1 is a cross-section of an active matrix monochrome electroluminescent display, the invention and its advantages apply equally well to passive matrix electroluminescent displays, segmented displays and colour displays. In passive matrix displays, the display pixels are usually separated by photoresist layers or structures. In the text below, embodiments of the invention will be described in detail with respect to a monochrome active matrix display as illustrated in FIG. 1.

In operating the electroluminescent display shown in FIG. 1, voltages can be applied to the various display pixels 6, 7 by display control means (not shown). If no voltage is applied to the electrodes 2, 5, no light is generated in the luminescent layer 4 and the pixel is ‘off’ as holds for pixel 7 in FIG. 1. If a voltage is applied to the luminescent layer 4, as holds for pixel 6, light is generated in this layer 4, i.e. the pixel is ‘on’. This light leaves the display pixel 6 through the transparent first electrode 2 and the transparent substrate 1 into the air, resulting in a direct image of the display pixel 6, indicated by the ray 10.

The light generated at the display pixel 6 is emitted Lambertianally, i.e. the light emission is distributed equally in each direction. Therefore, some light also traverses the substrate 1 as indicated by the rays 11. These rays 11 will be reflected internally (TIR) at the substrate-air interface and subsequently pass (i.e. crosstalk) to an adjacent display pixel 7. As illustrated in FIG. 1, the rays 11′ are reflected at the second reflective electrode 5 that acts as a mirror to these rays 11′. The reflected rays 11 then leave the display pixel 7 as rays 11″ because of the inclination of the second reflective electrode 5, resulting in an image of the display pixel 7. The inclination of the second electrode 5 is due to the slanting side walls 8, 9 of the holes in the insulating layer 3 for accommodating the display pixels 6, 7. Thus, while display pixel 7 is ‘off’, an image of this pixel is present due to crosstalk of light initiated at a pixel that is ‘on’ and reflected within the electroluminescent display. This image will hereinafter be referred to as a ghost image. Such a ghost image may also result from light that originates from outside the electroluminescent display, i.e. ambient light, and is reflected by the second electrode 5. Crosstalk of light between the display pixels 6, 7 creates a reduced contrast that is dependent on the viewing angle and may result in discolouration in colour displays due to mixing of light from the various colour (RGB) display pixels.

FIG. 2 shows various embodiments of the invention wherein the electroluminescent display comprises an insulating structure that is adapted to suppress the crosstalk of light between display pixels 6, 7 due to reflection of light at the second electrode 5. It will be appreciated that the display pixels are not necessarily adjacent to each other as is shown in FIG. 1. The light 11′ may originate as well or solely from a display pixel or display pixels that are further away, i.e. not adjacent to the second display pixel 7.

FIG. 2A shows a preferred embodiment wherein the slanting side wall 8 of the insulating layer 3 is properly shaped with respect to the angle Φ made by the slanting side wall 8 with respect to the surface of the substrate 1. It has been found that in practical situations as described below, an angle Φ of more than 40° substantially eliminates or reduces undesired reflection from the second electrode 5 of the light rays 11′, resulting in a ghost image from the display pixel 7 for all viewing angles. This embodiment will be discussed in more detail below.

FIG. 2B shows a preferred embodiment of the invention wherein the insulating layer 3 has a sufficiently high refractive index. For example, TiO₂ (n=2,5) or SnO₂ (n=2) may be used for this dielectric layer. The high refractive index results in an increased refraction at the interface of the substrate 1 and the insulating layer 3, thereby effectively suppressing crosstalk of light between the display pixels 6, 7.

FIG. 2C shows a preferred embodiment of the invention wherein the surface 12 of the slanting side wall 8 of the insulating layer 3 has been roughened. Such a roughening can be easily obtained by reactive ion etching (RIB). Alternatively, a rough surface 12 can be obtained by depositing various thin insulating layers with decreasing width parallel to the substrate 1 so as to obtain a step-like insulating layer 3. The advantage over RIE of such an approach is the avoidance of pin-holes in the insulating layer 3. The effect of the rough surface 12 of the slanting side wall 8 is that TIR-light 11′ from the substrate-air interface is diffused instead of reflected by the second electrode 5, resulting in a substantial decrease of the amount of light 11″ for the ghost image of the display pixel 7.

FIG. 2D shows a preferred embodiment of the invention wherein the surface 13 of the side wall of the insulating layer 3 is properly curved, convex, so as to prevent crosstalk of light to the display pixel 7. The curvature of the side wall 13 can be obtained by isotropic etching of the insulating layer 3.

In FIGS. 2A to 2D, the insulating structure is implemented by making adjustments for the shape or material of (parts of) the insulating layer 3. These adjustments can be very easily implemented in the manufacturing process of the electroluminescent displays, because no or only few additional process steps are required. These insulating structures provide an effective way of suppressing the appearance of ghost images of display pixels 7 due to light from other display pixels 6 or ambient light. The contrast of the display pixels 6, 7 is optimal and discolouration in colour displays is eliminated.

A second approach to an effective elimination of crosstalk between the various display pixels 6, 7 or ambient light effects relates to the application of light-absorbing materials. Various embodiments of this approach are shown in FIGS. 2E-2G.

FIG. 2E shows a preferred embodiment of the invention wherein the insulating layer 3 comprises light-absorbing particles such as carbon particles. The light-absorbing particles provide effective crosstalk prevention means in that the TIR-rays 11′ are absorbed by the particles prior to or after reflection at the second electrode 5, as a result of which substantially no light 11″ leaves the insulating layer 3.

FIG. 2F shows a preferred embodiment of the invention wherein an absorbing grid 14, i.e. a black matrix, has been applied underneath the slanting side wall 8 of the insulating layer 3. TIR-rays 11′ are prevented by the black matrix 14 from entering or leaving the insulating layer 3 as rays 11″ so that crosstalk between the display pixels 6, 7 is suppressed or optimally eliminated.

Finally, FIG. 2G shows a preferred embodiment of the invention wherein the second reflective electrode 5 has been partially removed above the slanting side wall of the insulating layer 3. It will be appreciated that application of voltages to the display pixels 6, 7 should still be possible. Preferably, the bare parts of the insulating layer are covered by an absorbing material 15. In this embodiment, the effect of the second electrode 5 acting as a mirror is significantly reduced, as a result of which crosstalk between the display pixels 6, 7 is reduced.

FIG. 3 shows three cases A-C, referring to FIG. 2 A, wherein the angle Φ of the slanting side wall 8 of the insulation layer 3 is varied. θ₂ is the angle of refraction of the TIR-rays 11′ at the interface of the substrate 1 and the insulating layer 3; the angle θ₅ refers to the viewing angle with respect to the normal of the substrate 1. In A, the case 0<Φ<θ₂/2 is shown and θ₅>0; in B, θ₂/2<Φ<θ₂ and θ₅<0 and in C, Φ>θ₂ while no light output is present.

Since θ₁^{lim}<θ₁<90° and θ₄^{lim}<θ₄<90° must hold for total internal reflection at the substrate-air interface, application of Snell's law results in the expression Φ>Φ^{lim}=(θ₂^{max}+θ₂^{min})/2, for the minimum angle n of the slanting side wall 8 of the insulating layer 3 so as to prevent crosstalk of light between the various display pixels 6, 7. θ₂^{max} and θ₂^{min} are the maximum and minimum angles of refraction at the interface of the substrate 1 and the insulating layer 3 relating to the maximum and minimum angle θ₁ of incidence, respectively, of the light 11. Taking n=1 as the refractive index n for air, n=1.5 for the substrate 1 composed of glass and SiO₂ and n=2 for the insulating layer 3, this results in a minimum angle Φ^{lim} of approximately 39° for the slanting side wall 8.

Further analysis of the embodiment of FIG. 2A results in the graphs shown in FIGS. 4A and 4B. FIG. 4A shows a range R of angles Φ for which a ghost image comes from the display at a particular viewing angle ↓⁵. An angle Φ of more than 40° for the slanting wall of the insulating layer 3 is sufficient to avoid unwanted reflections at the second electrode so that no ghost image is generated at any of the viewing angles θ₅. FIG. 4B provides an alternative representation of this result, wherein the graphs (A), (B) and (C) correspond to the cases A-C shown in FIG. 3.

For the purpose of teaching the invention, preferred embodiments of the display device and the electronic device comprising such a display device have been described above. It will be apparent to the person skilled in the art that other alternative and equivalent embodiments of the invention can be conceived and reduced to practice without departing from the true spirit of the invention, the scope of the invention being only limited by the claims.

1. An electroluminescent display comprising at least a first display pixel (6) and a second display pixel (7) formed on a substrate (1), said first and second display pixels comprising at least:
a first electrode (2) deposited on or across said substrate (1),
an electroluminescent layer (4), and
a second reflective electrode (5),
wherein said first display pixel (6) and said second display pixel (7) are separated by a region comprising at least one insulating structure (3), characterized in that said insulating structure (3) is adapted to suppress the output of light (11″) at said second display pixel (7) reflected at said second reflective electrode (5), which light (11″) originates from light (11′) incident from at least said first display pixel (6) and/or said substrate (1).

2. An electroluminescent display as claimed in claim 1, wherein said insulating structure (3) comprises at least one edge near or along said second display pixel (7).

3. An electroluminescent display as claimed in claim 2, wherein said edge comprises at least one slanting side wall (8) having an angle 4) towards said second display pixel (7).

4. An electroluminescent display as claimed in claim 3, wherein said angle Φ is larger than (θ₂^{max}+θ₂^{min})/2, with θ₂^{max} and θ₂^{min} being the maximum and minimum angles of refraction at the interface of the substrate (1) and the insulating structure (3), respectively.

5. An electroluminescent display as claimed in claim 3 or 4, wherein said angle Φ is chosen to be dependent on a desired viewing angle θ₅ in accordance with FIG. 4A.

6. An electroluminescent display as claimed in claim 3, 4 or 5, wherein said angle Φ is larger than 40°.

7. An electroluminescent display as claimed in claim 1, wherein said insulating structure (3) is made of a material with a refractive index which is equal to or higher than 2.0.

8. An electroluminescent display as claimed in claim 7, wherein said insulating structure (3) comprises TiO₂ or SnO₂.

9. An electroluminescent display as claimed in claim 3, wherein said insulating structure (3) comprises a roughened surface (12) of said slanting side wall (8).

10. An electroluminescent display as claimed in claim 3, wherein said insulating structure (3) comprises a curved side wall (13).

11. An electroluminescent display as claimed in claim 1 or 2, wherein said insulating structure (3) comprises light-absorbing particles.

12. An electroluminescent display as claimed in claim 3, wherein said insulating structure (3) comprises a light-absorbing grid (14) suitably deposited underneath said slanting side wall (8).

13. An electroluminescent display as claimed in claim 1 or 2, wherein said insulating structure (3) comprises a light-absorbing material (15) which partly replaces said second reflective electrode (5).

14. An electroluminescent display as claimed in claim 1, wherein said insulating structure (3) is adapted in accordance with a combination of any one of the preceding claims.

15. An electronic device comprising an electroluminescent display as claimed in any one of the preceding claims.
